(19) United States
(12) Patent Application Publication
(10) Pub. No.: US 2016/0048792 A1
(43) Pub. Date: Feb. 18, 2016

(54) DATA MODIFICATION IN HYPOTHETICAL PLANNING WITH BRANCHING DELTAS

(71) Applicant: SAP SE, Walldorf (DE)

(72) Inventors: Sheldon J. Finkelstein, Los Altos Hills, CA (US); Anil Kumar Goel, Waterloo (CA)

(21) Appl. No.: 14/462,522

(22) Filed: Aug. 18, 2014

(51) Int. Cl. G06Q 10/06

(52) U.S. Cl. CPC G06Q 10/06375

(57) ABSTRACT

A system, medium, and method including receiving a request to initiate a hypothetical transaction at a first logical time including changes made to a actual table and storage of the actual table being represented by a main storage data structure and a delta storage data structure; generating a hypothetical delta storage data structure to include the changes made by the hypothetical transaction, the hypothetical delta storage data structure being separate and distinct from the delta storage data structure; and applying the changes made by the hypothetical transaction included in the hypothetical delta storage data structure to the actual table to obtain a hypothetical result data structure that includes the data of the actual table existing at the first logical time and any changes made by the hypothetical transaction.

### BACKGROUND

Hypothetical analysis is used in a range of business areas and business functions. For example, Enterprises planning future actions may want to take advantage of certain Data Science capabilities to try to determine what actions could benefit them the most. Data Science functionalities might include mining results of past actions, learning likely correlations, predicting trends and simulating effects of the hypothetical actions. These functionalities could help suggest both reasonable business strategies and evaluate the effects of pursuing those strategies. Such evaluation is quite difficult in complex environments where competitors, customers and economies dynamically evolve.

### BRIEF DESCRIPTION OF THE DRAWINGS

FIG. 1 is a schematic block diagram of a system, according to some embodiments;

FIG. 2 is an illustrative depiction of a table, according to some embodiments;

FIG. 3 is an illustrative depiction of a table with hypothetical changes to the table of FIG. 1, in accordance with some embodiments;

FIG. 4 is an illustrative depiction of a table with the hypothetical changes of the table of FIG. 3 applied thereto, according to some embodiments;

FIG. 5 is a flow diagram of a process, according to some embodiments;

FIG. 6 is an illustrative schematic depiction of a process, in accordance with some embodiments;

FIG. 7 is an illustrative depiction of a storage structure for a table, according to some embodiments;

FIG. 8 is an illustrative depiction of a storage structure for a table, according to some embodiments;

FIG. 9 is an illustrative depiction of a storage structure for a table, according to some embodiments;

FIG. 10 is an illustrative depiction of a storage structure for a table having hypothetical changes applied thereto table, according to some embodiments; and

FIG. 11 is an illustrative depiction of an apparatus, according to some embodiments;

### DETAILED DESCRIPTION

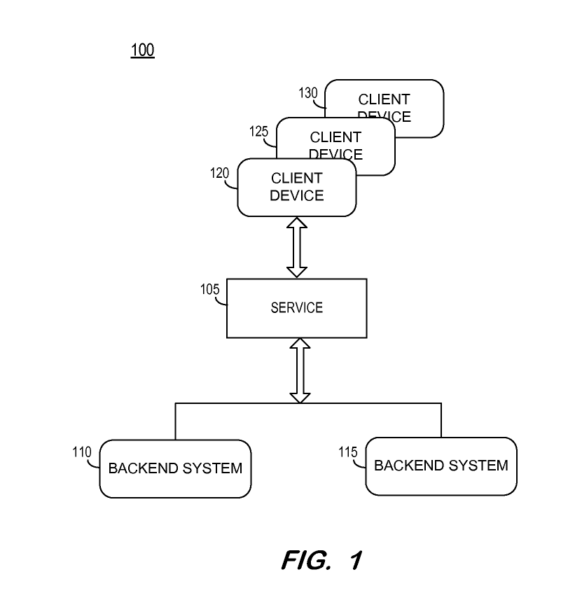

FIG. 1 is a block diagram of a system 100, according to some embodiments herein. System 100 represents a logical architecture for describing a system, apparatus, and processes for a hypothetical planning and other contexts where hypothetical change(s) to data and the effects of those changes may be calculated and visualized, while limiting the impact of those changes to the existing data. Actual implementations of system 100 may include more or different components arranged in other manners than that shown in FIG. 1.

System 100 includes a service 105 that may be developed and delivered to one or more entities such as, for example, client devices 120, 125, and 130. In some aspects, service 105 may be a cloud-based service provided by a service provider thereof. Service 105 may be supported and facilitated by one or more backend systems 110 and 115. Backend systems 110 and 115 may include hardware, software, and combinations thereof configured to deliver and make service 105 available to client devices 120, 125, and 130. Backend systems 110 and 115 may include, alone and/or in combination, processors, different types of memory, software applications and operating systems, communication devices, and interface mechanisms to facilitate communication between the different components and a framework or platform to deliver service 105.

Service 105 may comprise an application server, an enterprise application, a messaging service (e.g., a mail service), a social networking service, a data center to provide resources from data sources (not shown), and other systems, devices, components, and resources. In some aspects, service 105 may include an enterprise application used for conducting enterprise planning and analysis. Some such enterprise applications may include, for example, Enterprise Performance Management, Financial Planning, Sales and Opportunity Planning, and Business Warehouse Planning applications provided by the assignee hereof, SAP SE. These, and other, planning applications may be used for decision support and report generation transactions, as well as for warehouse analysis.

In some instances, service 105 may include a cloud based application, system, service, or resource that provides a service, resource, and/or access to a service or resource to client devices 120, 125, and 130. Service 105 may be delivered by a service provider remotely located from client devices 120, 120, 125, and 130. Communication between the client devices, service provider, and the backend systems may be accomplished using any communication protocol known and that becomes known.

In some aspects, an enterprise application and/or an administrator, user, or other entity may have a desire to analyze one or more “what if” results in parallel to an on-going operation of a data management system. In some regards, it may be desirable to analyze the different “what if” scenarios for one or more different hypothetical actions while also allowing other applications and processes to concurrently perform actual updates and other operations on the underlying data in a manner such that the hypothetical (i.e., “what if”) operations do not interfere with each other or with actual updates and other changes to the data.

Some database systems offer a form of snapshot isolation capabilities so that transactions can operate on data as the data existed as of particular (logical) times, usually when each transaction or a statement within a transaction started. With a basic form of snapshot isolation, changes of the same data by different transactions would interfere with each other, even if those changes were hypothetical modifications in transactions that support analysis but would never be committed.

In some embodiments, a “Branching Deltas” approach to perform hypothetical data changes is disclosed herein. The disclosed approach uses an innovative and efficient computation process to leverage visibility semantics that may already be used for implementing snapshot isolation by, for example, multiversion concurrency (MVCC) systems such as SAP HANA. Herein, the disclosed “Branching Deltas” approach may be described primarily in context of and based on SAP HANA's in-memory database management system design. However, the approach disclosed herein, including a variation of the “Branching Deltas” approach, may be extended to encompass and be implemented for other database management systems using snapshot isolation (e.g., MVCC systems) and other isolation levels (notwithstanding different semantics) such as Read Consistency.

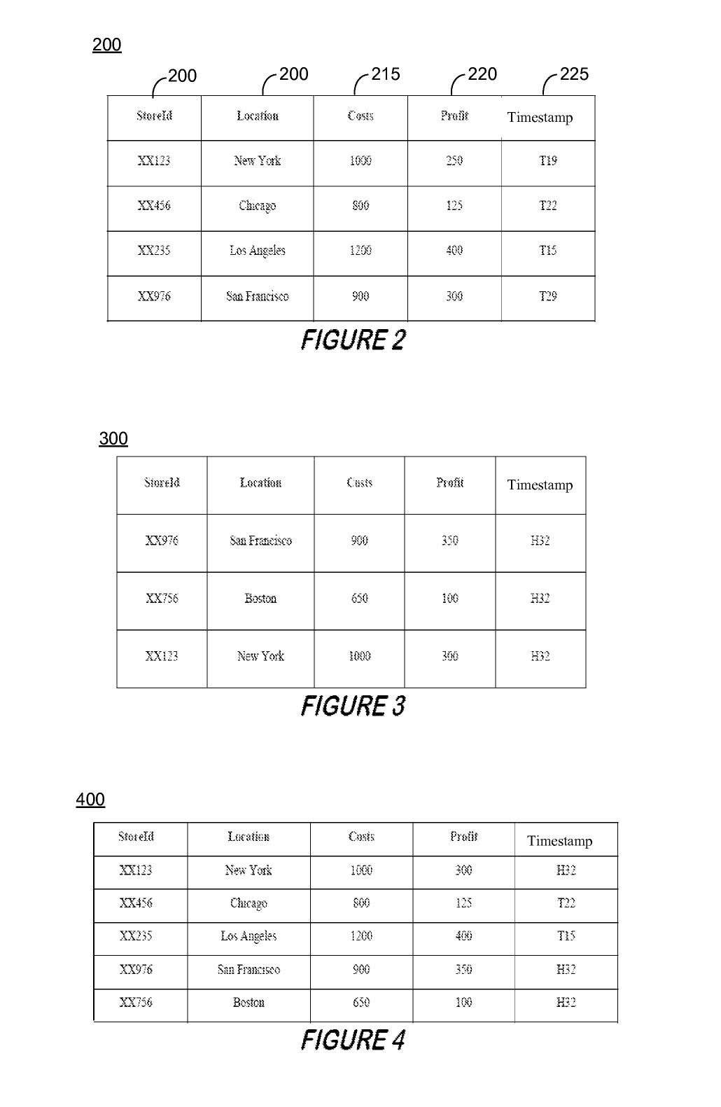

FIG. 2 is an illustrative example of a table (T), generally referenced at numeral 200, including a collection or set of data. In this example, the table T (200) has a key StoreId 205. Other columns of table T represent a given store's Location 210, Costs 215, and Profit 220. Also listed in table T of FIG. 1 is a hidden internal Timestamp indicating when that data was committed to a database housing the data. Data for a row of table T is current as of the listed Timestamp, but when data for that row is updated by a subsequent transaction that commits, a new entry for that row with a later Timestamp will be generated and that data will then be current. Implementations of database tables may often include a RowId, but for simplicity of this example the rows will be distinguished based on an immutable StoreId 205 key. In some aspects, data for tables herein may be stored in row or column format.

FIG. 2 shows an instance of table T with rows that are current as of logical time T29. There may be earlier versions of the rows in the table, but those are not shown in the present example since they will not be visible to transactions begun after the rows in FIG. 2 were committed. Database management systems, including MVCC systems, that provide snapshot isolation may handle such visibility consideration(s) transparently.

Table 300 T′ is illustrated in FIG. 3. Table 300 is a hypothetical modification table T′ that includes some hypothetical modifications to table T. As seen in table 300, table T′ includes two updates (one for the San Francisco store and one the New York store) and one insertion (for the Boston store). In some aspects, the Timestamp field reflects the logical time that a transaction commits. For transactions that are in-flight, the Timestamp field may include a TransactionId (distinguishable from a logical time), which will be replaced by the commit time if the transaction commits. In FIG. 3, H32 has been entered for the Timestamp to emphasize that these changes are part of a hypothetical transaction that began at logical time T32 but has not committed. In some aspects, the data shown in table T 200 of FIG. 2 would be visible to that hypothetical transaction, as would the modifications made by the hypothetical transaction itself.

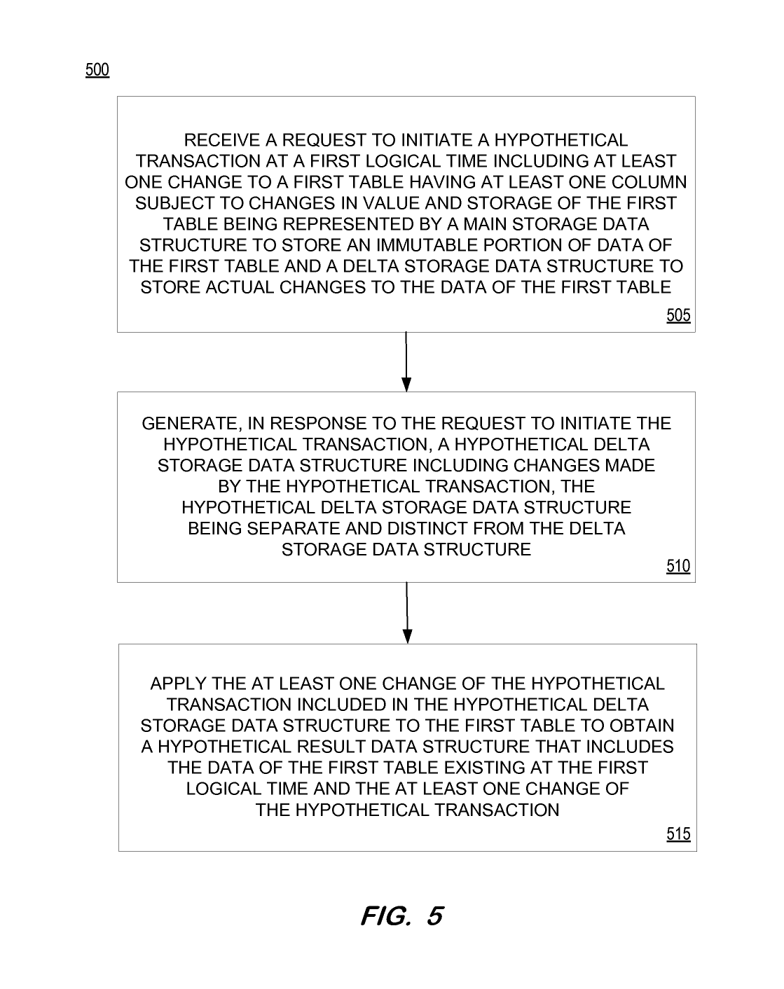

If there were multiple simultaneous hypothetical transactions, they would have separate Timestamps. In some regards, actual transactions do not see changes made by hypothetical transactions. Modifications to an actual table committed after a hypothetical transactional started would not be visible to the hypothetical transaction. Furthermore, hypothetical transactions herein do not commit and do not hold locks on data, unless specifically noted herein for a particular instance or circumstance.

Whereas table T 200 illustrates the data as it existed at the start of a hypothetical modification of that data and table T′ 300 illustrates the hypothetical changes to be made to the data of table T, FIG. 4 shows a result table T″ 400 visible to the hypothetical transaction when the modification in table T′ 300 are applied to table T 200. Herein, this operation is referred to as the OverWrite of T by T′. Referring to table T″ 400, it is seen that a row including the Boston store was inserted and information for the New York and San Francisco stores was updated.

For the example of FIGS. 2-4, changes to the listed data only occurred in one column, the column labeled “Profit”. However, the overwriting of T by T′ operation discussed herein may easily be expanded and applied to instances where multiple columns (and multiple tables) are hypothetically changed (e.g., insertions, updates, deletions). Further disclosures herein may also be illustrated, for sake of clarity and demonstration of particular processes and techniques, with examples of hypothetical data modifications to a single column of a table, although these further processes and techniques may generally be applicable to and encompass changes to multiple columns and multiple tables.

In some aspects, hypothetical transactions including deletions of data may be handled in a number of different methods. One method to handle deletions is to enter a “tombstone” indicating that a given row has been deleted as of a specific logical time (or during an in-flight transaction). Another method that may be used is to enter null or other default value (e.g., zero) for the non-key columns of a row that is deleted. The former method may be used in some embodiment herein, although the latter method may also be used.

While the processes herein may be described in relation to SAP HANA in some embodiments, aspects of the present disclosure may find applicability in other (SQL) databases. That is, embodiments of the present disclosure are not limited to SAP HANA, neither specifically nor completely, and may be generically applicable to other database management systems.

The present disclosure will now describe how the results shown in FIG. 4 illustrating an OverWrite of T (FIG. 2, table 200) by the modifications in T′ (FIG. 3, table 300) may be efficiently calculated using a “Branching Deltas Approach” that will be discussed in detail hereinbelow. In the following discussion, T′ is the hypothetical modification table.

In the following example, it will be assumed that modifications/updates change only a single column, in this case, the column labeled “Profit”. In some embodiments, changes may occur in at least one column of at least one table of a collection or set of data related to hypothetical planning herein.

FIG. 5 is an illustrative flow diagram of a process 500, in accordance with some embodiments herein. In some embodiments, various hardware elements of system 100 may execute program instructions to perform process 500. In some embodiments, hard-wired circuitry may be used in place of, or in combination with, program instructions for implementation of processes according to some embodiments. Embodiments are therefore not limited to any specific combination of hardware and software.

In some embodiments, prior to operation 505, tables T and T′ including data persisted in a database may be generated. Storage of data in the tables (e.g., T and T′) may comprise two data structures—a Main storage (i.e., Main) and a Delta storage (i.e., Delta) in terms of SAP HANA. In some aspects, the Main storage may be defined and optimized for read performance and memory consumption (i.e., dictionary compression and other memory compression techniques) and may be immutable or read-only. The Delta storage may be defined and optimized for modifications to be made to the data stored in the Main. An online Delta Merge may be run periodically on tables, based on triggers such as Delta size or time, to produce a new, read efficient Main. Since Delta Merge is a background task, database work continues during Delta Merge. Other details and specific characteristics of the Main and Delta exist and are not discussed herein in great detail.

In some aspects, a principal property of the “Branching Deltas” approach disclosed herein to be implementable in a database system is the capability that all new modifications to a table go into a separate partition, with visibility semantics determined by “latest entry” for rows even when, for example, they are in different partitions. This property may have value for other reasons; for example, bulk inserts or streams might be pre-processed to create a new partition (or a new part of a partition) in an efficient (perhaps binary) form. This disclosure is applicable to database systems that do not have Main and Delta as described for HANA. For example, it could be embodied in database systems that support visibility semantics for modifications across multiple stores, or even (as will be shown in [0040]) in systems with a single store.

For systems like SAP HANA that have Main and Delta, or possibly multiple deltas, the idea of “Branching Deltas” may be readily employed. Namely, an additional delta may be generated and used for each hypothetical transaction, similar to the hypothetical modifications (T) presented in FIG. 3. In terms of visibility, data for a row that is entered into a Delta already OverWrites data for that row that was entered before it, whether that data was in Main or Delta. With the snapshot isolation of the database management system, a transaction, whether actual or hypothetical, only sees data that was committed before it began, as well as its own modifications.

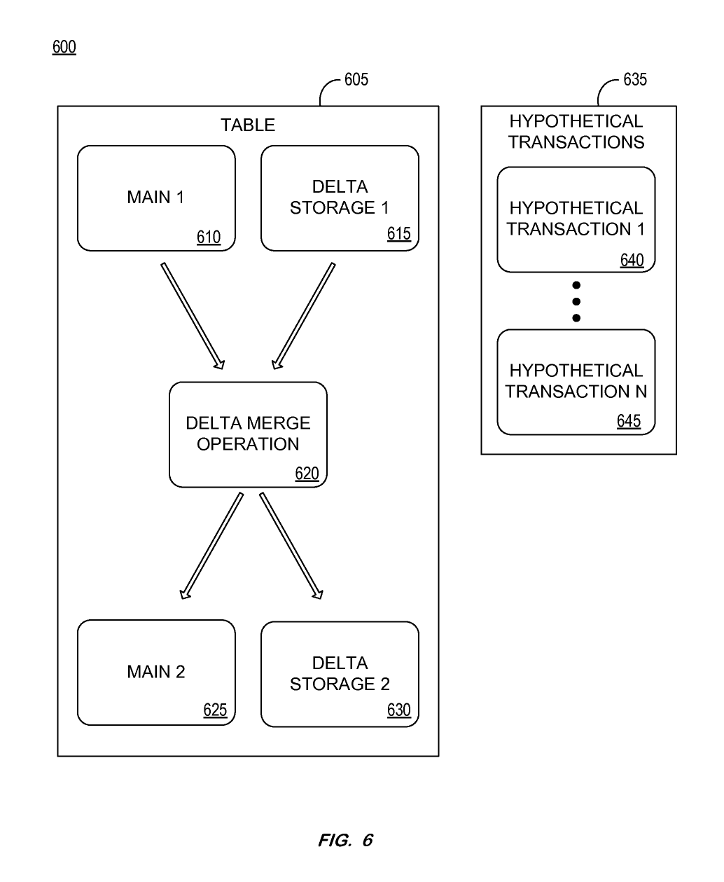

The term “Branching Deltas” is used herein because a new “branching” Hypothetical Delta is created for each hypothetical transaction, in some embodiments herein. Instead of defining visibility based on a Main overwritten by the standard Delta, the data management system defines visibility for a hypothetical transaction based on (Main OverWritten by Delta) OverWritten by the hypothetical transaction's Hypothetical Delta. FIG. 6 is an illustrative depiction of some aspects of a database management system 600 that uses a Main data structure and a Delta data structure for storing a table. Table 605 includes a Main and a Delta. Data comprising table 605 at a first logical time is represented by Main 1 605 and Delta 1 610. In some circumstances, including but not limited to an effort to optimize query execution and optimum memory utilization and time and/or Delta size triggers, system 600 may transfer data from Delta 1 to the Main portion of storage. This transfer process is referred to as a Delta Merge and is illustrated at 620. After the Delta Merge operation at 620, the table is represented by a new Main (Main 2 625) and a new Delta (Delta 2 630), where the new Delta included modifications that occurred after the Delta Merge began. Main 2 and Delta 2 become the Main and the Delta for the table and Main 1 and Delta 2 are discarded post-Delta Merge.

Further illustrated in FIG. 6 is an illustrative depiction of hypothetical transactions 635. As illustrated, modifications made by hypothetical transactions are logically separate from the actual transactions to data that are captured and represented by the Main and Delta processing of table 605. The separation conveyed in FIG. 6 represents, in part, the aspect that the hypothetical transactions 635 are not visible to the actual transactions that impact the Main and Delta. As further shown, system 600 may be process multiple hypothetical transactions (i.e., hypothetical transactions 640 through 645).

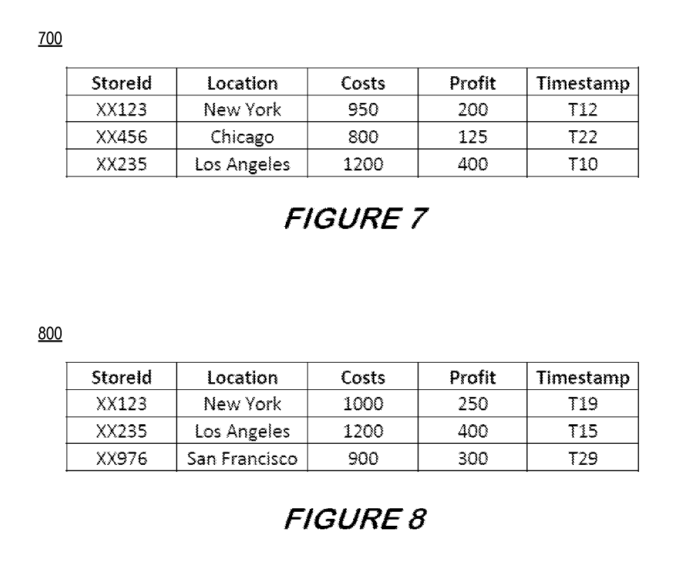

Returning to FIG. 5, operation 505 includes receiving a request to initiate a hypothetical transaction at a first logical time where the hypothetical transaction includes changes made to an actual table. In accordance with some embodiments herein, the storage of the actual table is represented by a Main storage data structure to store an immutable portion of data of the actual table and a Delta storage data structure to store subsequent changes to the data of the actual table. FIG. 7 is a representation of the Main portion 700 of the actual table and FIG. 8 is an illustrative depiction of the Delta portion 800 of the actual table. It is noted that combining Main 700 and Delta 800 would yield the table T depicted in FIG. 2.

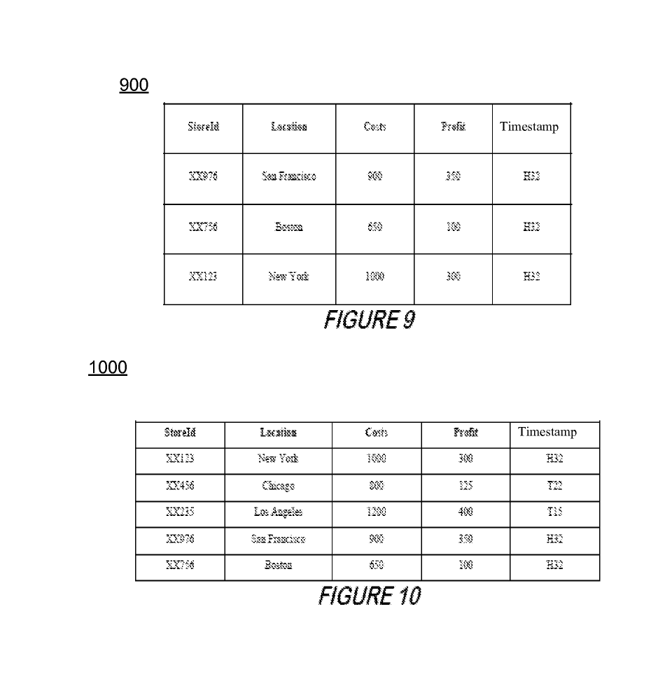

Operation 510 of process 500 includes generating, in response to the request to initiate the hypothetical transaction, a Hypothetical Delta storage data structure to include any changes made by the hypothetical transaction. FIG. 9 is an illustrative depiction of the Hypothetical Delta 900 generated at operation 510, which is separate and distinct from the Delta storage (i.e., Delta 800) data structure. It is noted that Hypothetical Delta 900 includes the hypothetical data changes discussed above, including the hypothetical data updates (i.e., New York and San Francisco) and the hypothetical insertion (i.e., Boston) to the actual table. It could also include hypothetical deletions, which in some embodiments could be marked by tombstones indicating that data is no longer present. It is noted that Delta 900 includes the same data representation as table T′ depicted in FIG. 4.

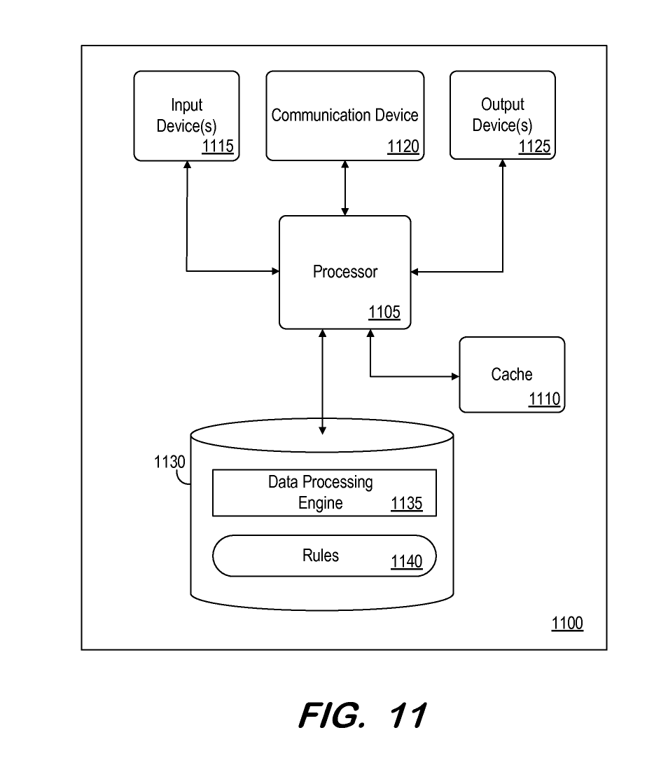

Process 500 proceeds to operation 515 that includes applying the changes of the hypothetical transaction included in the hypothetical Delta to the actual table to obtain a hypothetical result data structure that includes the data of the actual table existing at the first logical time and the changes made by the hypothetical transaction. FIG. 10 is an illustrative depiction of the Hypothetical result 1000 generated at operation 515, where the branching delta, Delta 900, has been applied to table T. It is noted that Hypothetical result 1000 is the same as the data representation as the table T depicted in FIG. 4.

In some aspects, the “Branching Deltas” approach disclosed herein involving hypothetical transactions does not hold locks and does not commit data to storage. Accordingly, the hypothetical transactions do not interfere with each other or with actual transactions. While some memory is required for hypothetical modifications, the original data is not copied. In some embodiments, a programmer must specify or otherwise indicate that a transaction is hypothetical to invoke some of the aspects disclosed herein. In some embodiments, an underlying system may be changed so that a Hypothetical Delta is created for any table that is modified and modifications are placed into that Hypothetical Delta, not the (actual) Delta used by actual transactions. In some regards, the rolling back of a hypothetical transaction may only require that the Branching or Hypothetical Deltas of the hypothetical transaction be dropped.

In some embodiments, instead of entering a hypothetical transaction's modifications in a Hypothetical Delta, the modifications could be entered (with the TransactionId of the hypothetical transaction) into the standard Delta. Since hypothetical transactions never commit and hold no locks, hypothetical transactions of this example would still not interfere with each other or with actual transactions. When such a hypothetical transaction rolls back, the modifications entered on its behalf into the standard Delta are irrelevant, just as they would be for an actual transaction that rolled back. If a Delta Merge occurs before the hypothetical transaction is rolled back, its changes will be in the new Main but once again they are irrelevant just as they would be for an actual transaction and they will be discarded the next time the Delta Merge occurs.

In some respects, an advantage of putting hypothetical modifications into the standard Delta, rather than a Hypothetical (Branching) Delta, is that there is a single OverWrite, rather than two OverWrites. Moreover, no special check needs to be made to see if a given transaction is hypothetical or not when determining visibility. Conversely, entering hypothetical modifications into the standard Delta may fill up the standard Delta more quickly and require additional work by an actual transaction to scan the hypothetical modifications and ignore them.

In some embodiments, a principle needed for “Branching Deltas” to be implementable is the ability for multiple “partitions” to store versions of the same row, with the right visibility semantics. However, Applicants have realized that one can implement “Branching Delta” capabilities while performing modifications in the partition assigned to the row (e.g., by hash or range partitioning). This methodology may work for many database systems providing snapshot isolation, particular those based on MVCC, as well as other isolation methods, such as Read Committed.

FIG. 11 is a block diagram overview of a system or apparatus 1100 according to some embodiments. System 1100 may be, for example, associated with any of the devices described herein, including for example a system or apparatus to support and facilitate hypothetical planning of a service delivered by system 100, in accordance with processes disclosed herein. System 1100 comprises a processor 1105, such as one or more commercially available Central Processing Units (CPUs) in the form of one-chip microprocessors or a multi-core processor, coupled to a communication device 1120 configured to communicate via a communication network (not shown in FIG. 11) to another device or system (e.g., a client device). Some embodiments may operate on data in client devices. In the instance system 1100 comprises a device or system, communication device 1120 may provide a mechanism for system 1100 to interface with a an application, device, system, or service. System 1100 may also include a cache 1110, such as RAM memory modules. The system may further include an input device 1115 (e.g., a touchscreen, mouse and/or keyboard to enter content) and an output device 1125 (e.g., a touchscreen, a computer monitor to display, a LCD display).

Processor 1105 may communicate with a storage device 1130. Storage device 1130 may comprise any appropriate information storage device, including combinations of magnetic storage devices (e.g., a hard disk drive), optical storage devices, solid state drives, and/or semiconductor memory devices. In some embodiments, storage device 1130 may comprise a database system, including in some configurations an in-memory database.

Storage device 1130 may store program code or instructions for a data processing engine 1135 that may provide processor executable instructions for hypothetical planning processes, in accordance with processes herein. Processor 1105 may perform the instructions of the data processing engine 1135 to thereby operate in accordance with any of the embodiments described herein. The program instructions for data processing engine 1135 may be stored in a compressed, uncompiled and/or encrypted format. Program instructions for data processing engine 1135 may furthermore include other program elements, such as an operating system, a database management system, and/or device drivers used by the processor 1105 to interface with, other devices and systems (not shown in FIG. 11). Storage device 1130 may also include data 1140 such as rules for determining the disclosed calculations in some embodiments herein. Data 1140 may be used by system 1100, in some aspects, in performing one or more of the processes herein, including individual processes, individual operations of those processes, and combinations of the individual processes and the individual process operations.

All systems and processes discussed herein may be embodied in program code stored on one or more tangible, non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

In some embodiments, aspects herein may be implemented by an application, device, or system to manage recovery of an entity or other application in a consistent manner across different devices, effectively across an entire domain.

In some aspects and embodiments, additional or alternative extensions of the processes and techniques disclosed herein may be extended to allow hypothetical transactions to persist updates to special tables. Instead of throwing away results, a hypothetical transaction may write results to their hypothetical modification tables and perhaps to other special “Hypothetical Analysis” files or tables, supporting comparison and analysis of results across multiple planning exercises and simulations. Modifications to standard tables would be treated as described earlier, with neither locks nor persistence.

In some embodiments, additional or alternative extensions may allow hypothetical transactions to commit changes to standard tables, as well as special tables. If there are no conflicts, this is relatively simple; if there are conflicts, they could be resolved in various ways including, for example, last one wins; when updates are commutative or otherwise composable, compose them together; show conflicts to planner and have planner decide how to resolve them; and roll back the effects of the hypothetical transaction; determine intent of hypothetical transaction, and apply that to current state of the database.

In some embodiments, additional or alternative extensions may allow hypothetical planners to see their proposed changes applied to the current state of the database (always or on request), so that they have a more current view of effects of their plans. Conflicts could be resolved as described for the previous item.

In some embodiments, additional or alternative extensions may allow recursive hypothetical planning, where after initial planning a hypothetical plan might consider hypothetical alternatives, choose the best, and continue planning.

In some embodiments, additional or alternative extensions may generalize hypothetical transactions to hypothetical processes, or other planning scenarios involving multiple transactions. One variation of allows a planner to create alternative worlds (e.g., with different supplies and prices) and play actual transactions against those alternative worlds, observing a subset of the financial consequences in that alternative world. In some embodiments, a hypothetical table herein does not have to be materialized.

Although some embodiments have been described with respect to cloud-based entities, some embodiments may be associated with other types of entities that need not be cloud-based, either in part or whole, without any loss of generality.

The embodiments described herein are solely for the purpose of illustration. Those in the art will recognize other embodiments which may be practiced with modifications and alterations.

What is claimed is:

1. A method implemented by a computing system in response to execution of program instructions by a processor of the computing system, the method comprising:
receiving a request to initiate a first hypothetical transaction at a first logical time, the first hypothetical transaction including any changes to one or more actual tables and storage of the actual table being represented by a main storage data structure to store an immutable portion of data of the actual table and a delta storage data structure to store actual changes to the data of the actual table;
generating, in response to the request to initiate the first hypothetical transaction, a hypothetical delta storage data structure to include any changes made by the hypothetical transaction, the hypothetical delta storage data structure being separate and distinct from the delta storage data structure; and
logically applying the changes made by the first hypothetical transaction included in the hypothetical delta storage data structure to the actual table to obtain a hypothetical result data structure that includes the data of the actual table existing at the first logical time and any changes made by the first hypothetical transaction.

2. The method of claim 1, wherein the first logical time is logically later than all logical times associated with the data of the actual table when the request to initiate the first hypothetical transaction is received.

3. The method of claim 1, wherein data visible to a transaction other than the first hypothetical transaction is the data represented by the main storage data structure and the delta storage data structure of the actual table at a logical start time of the transaction other than the first hypothetical transaction.

4. The method of claim 1, further comprising:
undoing the changes made by the first hypothetical transaction; and
dropping the hypothetical delta storage data structure.

5. The method of claim 1, further comprising:
receiving a request to initiate a second hypothetical transaction at a second logical time, the second hypothetical transaction including any changes made to the actual table by the first hypothetical transaction;
generating, in response to the request to initiate the second hypothetical transaction, a second hypothetical delta storage data structure to include any changes made by the second hypothetical transaction, the second hypothetical delta storage data structure being separate and distinct from the delta storage data structure and the first hypothetical delta storage data structure; and
logically applying any changes made by the second hypothetical transaction included in the second hypothetical delta storage data structure to the actual table and the first hypothetical delta storage data structure to obtain a second hypothetical result data structure that includes the data of the actual table existing at the first logical time, any changes made by the first hypothetical transaction, and any changes made by the second hypothetical transaction.

6. The method of claim 5, wherein data visible to a transaction other than the first hypothetical transaction and the second hypothetical transaction is the data represented by the main storage data structure and the delta storage data structure of the actual table at a logical start time of the transaction other than modifications made by the first hypothetical transaction and the second hypothetical transaction.

7. A non-transitory medium storing processor-executable program instructions, the medium comprising program instructions executable by a computer to:
receive a request to initiate a first hypothetical transaction at a first logical time, the first hypothetical transaction including any changes made to a actual table in value and storage of the actual table being represented by a main storage data structure to store an immutable portion of data of the actual table and a delta storage data structure to store actual changes to the data of the actual table;
generate, in response to the request to initiate the first hypothetical transaction, a hypothetical delta storage data structure to include the changes made by the hypothetical transaction, the hypothetical delta storage data structure being separate and distinct from the delta storage data structure; and
logically apply the changes made by the first hypothetical transaction included in the hypothetical delta storage data structure to the actual table to obtain a hypothetical result data structure that includes the data of the actual table existing at the first logical time and the changes made by the first hypothetical transaction.

8. The medium of claim 7, wherein the first logical time is logically later than all logical times associated with the data of the actual table when the request to initiate the first hypothetical transaction is received.

9. The medium of claim 7, wherein data visible to a transaction other than the first hypothetical transaction is the data represented by the main storage data structure and the delta storage data structure of the actual table at a logical start time of the transaction other than the first hypothetical transaction.

10. The medium of claim 7, further comprising program instructions executable by a computer to:
undo the changes made by the first hypothetical transaction; and
drop the hypothetical delta storage data structure.

11. The medium of claim 7, further comprising program instructions executable by a computer to:
receive a request to initiate a second hypothetical transaction at a second logical time, the second hypothetical transaction including changes made to the actual table by the first hypothetical transaction;
generate, in response to the request to initiate the second hypothetical transaction, a second hypothetical delta storage data structure to include the changes made by the second hypothetical transaction, the second hypothetical delta storage data structure being separate and distinct from the delta storage data structure and the first hypothetical delta storage data structure; and
logically apply the changes made by the second hypothetical transaction included in the second hypothetical delta storage data structure to the actual table and the first hypothetical delta storage data structure to obtain a second hypothetical result data structure that includes the data of the actual table existing at the first logical time, the changes made by the hypothetical transaction, and the changes made by the second hypothetical transaction.

12. The medium of claim 11, wherein data visible to a transaction other than the first hypothetical transaction and the second hypothetical transaction is the data represented by the main storage data structure and the delta storage data structure of the actual table at a logical start time of the transaction other than the first hypothetical transaction and the second hypothetical transaction.

13. A system comprising:
a computing device comprising:
a memory storing processor-executable program instructions; and
a processor to execute the processor-executable program instructions to cause the computing device to:
receive a request to initiate a first hypothetical transaction at a first logical time, the first hypothetical transaction including changes made to a actual table and storage of the actual table being represented by a main storage data structure to store an immutable portion of data of the actual table and a delta storage data structure to store actual changes to the data of actual table;
generate, in response to the request to initiate the first hypothetical transaction, a hypothetical delta storage data structure to include the changes made by the hypothetical transaction, the hypothetical delta storage data structure being separate and distinct from the delta storage data structure; and
logically apply the changes made by the first hypothetical transaction included in the hypothetical delta storage data structure to the actual table to obtain a hypothetical result data structure that includes the data of the actual table existing at the first logical time and the changes made by the first hypothetical transaction.

14. The system of claim 13, wherein the first logical time is logically later than all logical times associated with the data of the actual table when the request to initiate the first hypothetical transaction is received.

15. The system of claim 13, wherein data visible to a transaction other than the first hypothetical transaction is the data represented by the main storage data structure and the delta storage data structure of the actual table at a logical start time of the transaction other than the first hypothetical transaction.

16. The system of claim 13, further comprising causing the computing device to:
undo the changes made by the first hypothetical transaction; and
drop the hypothetical delta storage data structure.

17. The system of claim 13, further comprising causing the computing device to:
receive a request to initiate a second hypothetical transaction at a second logical time, the second hypothetical transaction including changes made to the actual table by the first hypothetical transaction;
generate, in response to the request to initiate the second hypothetical transaction, a second hypothetical delta storage data structure to include the changes made by the second hypothetical transaction, the second hypothetical delta storage data structure being separate and distinct from the delta storage data structure and the hypothetical delta storage data structure; and
logically apply the changes made by the second hypothetical transaction included in the second hypothetical delta storage data structure to the actual table and the first hypothetical delta storage data structure to obtain a second hypothetical result data structure that includes the data of the actual table existing at the first logical time, the changes made by the first hypothetical transaction, and the changes made by the second hypothetical transaction.

18. The system of claim 17, wherein data visible to a transaction other than the first hypothetical transaction and the second hypothetical transaction is the data represented by the main storage data structure and the delta storage data structure of the actual table at a logical start time of the transaction other than the first hypothetical transaction and the second hypothetical transaction.

19. A method implemented by a computing system in response to execution of program instructions by a processor of the computing system, the method comprising:
receiving a request to initiate a first hypothetical transaction at a first logical time, the first hypothetical transaction including any changes to one or more actual tables and storage of the actual table being represented by a main storage data structure to store an immutable portion of data of the actual table and a delta storage data structure to store actual changes to the data of the actual table;
generating, in response to the request to initiate the first hypothetical transaction, a hypothetical delta storage data structure to include any changes made by the hypothetical transaction, the hypothetical delta storage data structure stored in the delta storage data structure; and
logically applying the changes made by the first hypothetical transaction included in the delta storage data structure to the actual table to obtain a hypothetical result data structure that includes the data of the actual table existing at the first logical time and any changes made by the first hypothetical transaction.

20. The method of claim 19, wherein the first logical time is logically later than all logical times associated with the data of the actual table when the request to initiate the first hypothetical transaction is received.

21. The method of claim 19, further comprising:
undoing the changes made by the first hypothetical transaction.

22. The method of claim 19, further comprising:
receiving a request to initiate a second hypothetical transaction at a second logical time, the second hypothetical transaction including any changes made to the actual table by the first hypothetical transaction;
generating, in response to the request to initiate the second hypothetical transaction, changes in the delta storage data structure to include any changes made by the second hypothetical transaction, the second hypothetical delta storage data structure stored in the delta storage data structure, distinguishable from changes made by the first hypothetical transaction and independently capable of being rolled back; and
logically applying any changes made by the second hypothetical transaction included in the hypothetical delta storage data structure on behalf of the second hypothetical transaction to the actual table as modified by the first hypothetical transaction's changes in the delta storage data structure to obtain a second hypothetical result data structure that includes the data of the actual table existing at the first logical time, any changes made by the first hypothetical transaction, and any changes made by the second hypothetical transaction.
